(19) United States
(12) Patent Application Publication
(10) Pub. No.: US 2012/0328778 A1
(43) Pub. Date: Dec. 27, 2012

(54) INFUSION OF POROUS MEDIA WITH A LIQUID CHEMICAL AGENT MIXTURE

(75) Inventors: John M. Forsythe, Nampa, ID (US); Henry John Duncan, Glasgow (GB); Curtis Lee Eames, Meridian, ID (US)

(73) Assignee: 1,4 GROUP, INC., Meridian, ID (US)

(21) Appl. No.: 13/530,489

(22) Filed: Jun. 22, 2012

Related U.S. Application Data
(60) Provisional application No. 61/499,764, filed on Jun. 22, 2011.

(51) Int. Cl. B05D 7/00

(52) U.S. Cl. 427/243

(57) ABSTRACT

Methods of infusing a porous media with a liquid chemical agent mixture are disclosed. In some embodiments, the methods include forming a solution of said chemical agent in a suitable solvent, introducing said chemical agent solution into contact with said porous media, and evaporating said solvent to deposit said chemical agent onto/into said porous media. In some embodiments, the chemical agent is CIPC.

### CROSS-REFERENCE TO RELATED APPLICATION

This application claims the benefit of U.S. Provisional Patent Application Ser. No. 61/499,764, filed Jun. 22, 2011, the disclosure of which is hereby incorporated herein in its entirety by this reference.

### TECHNICAL FIELD

Porous media infused with a liquid chemical useful for crop treatment. The porous media may be impregnated by immersion in a liquid chemical.

### BACKGROUND OF INVENTION

Various liquid volatile chemicals have been incorporated with porous inorganic media by soaking the media in the liquid chemical, then draining off the excess liquid. Tecnazene, a solid at room temperature, has been melted and mixed with alumina. Generally, these methods and chemicals have been used for experimental procedures. U.S. Pat. No. 5,918,537 disclosed a device containing porous media impregnated with dimethyl naphthalene. The patent further references prior articles setting forth the state of the art with reference to impregnated porous media.

Loose granules of clay mixed with CIPC have been used with respect to commercial storage of potatoes. Direct contact of potatoes, especially when freshly dug and damp, with CIPC tends to damage the potatoes. Also, use of clays as media tends to absorb moisture causing them to stick to the potatoes, generally presenting a clean-up problem when the potatoes are removed from storage (see U.S. Pat. No. 5,849,664).

CIPC, upon melting, forms a waxy, viscous material. Mixing of alumina or other inorganic particles, having an extended surface area, with molten CIPC tends to coat the exterior of the particles without infusing much of the CIPC into the interior extended skeletal surface of such minute particles. In order to effectuate good sprout inhibition via sublimation from solid CIPC, the CIPC surface area must be very large. Thus, unless the extensive interior area of porous inorganic media, such as alumina, is coated with CIPC, then a large amount of such media must be used and surface contact between the media and the potatoes generally must be avoided.

### BRIEF DESCRIPTION OF THE DRAWING

FIG. 1 is a schematic drawing illustrating a particular embodiment of a method of infusing a chemical agent into a porous media.

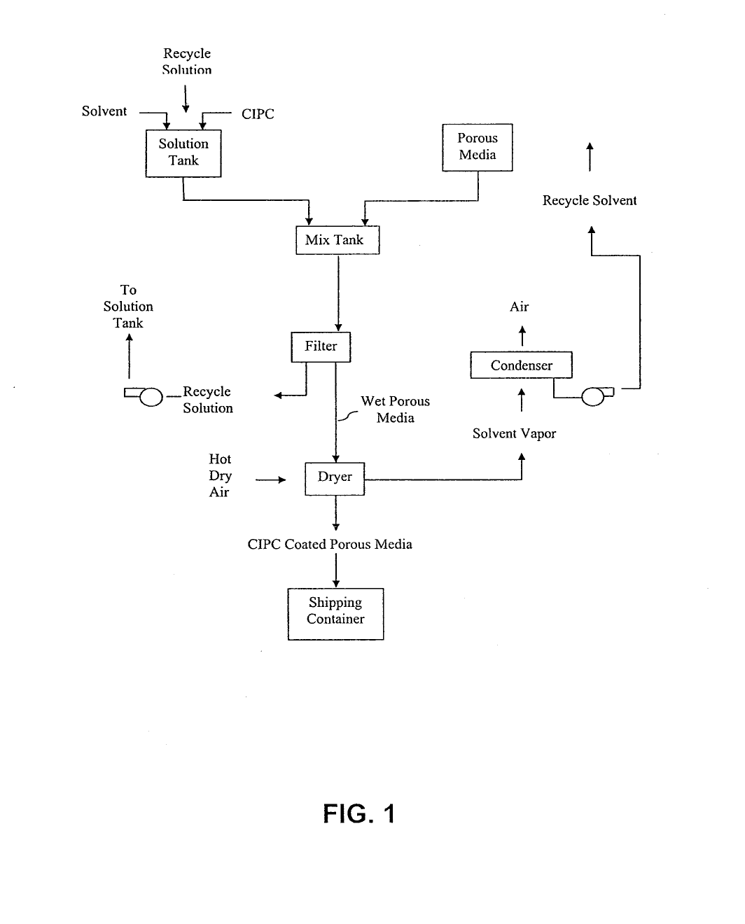

### BRIEF SUMMARY OF THE INVENTION

A particular embodiment of the invention is drawn to a method of infusing a chemical agent into a porous media that includes: forming a solution of said chemical agent in a suitable solvent; introducing said chemical agent solution into contact with said porous media; and evaporating said solvent to deposit said chemical agent onto/into said porous media.

Another embodiment of the invention is drawn to a method of placing a dual coating of active chemicals upon the extended surface of an inorganic porous media that includes: coating said porous media with a solution of a solute in a volatile solvent; evaporating said solvent to deposit a thin coating of said solute upon the extended surface of said porous media; and coating said porous media with a liquid chemical to form a thin layer of said liquid chemical on top of said base solute layer.

### DESCRIPTION OF THE INVENTION

A solution of active chemical in a volatile solvent is placed in contact with a porous media. The solvent may then be evaporated to deposit said active chemical throughout the surface of said porous media. Evaporation of the solvent may be enhanced by increasing the temperature of the porous media above the boiling point of the solvent. The evaporated solvent may be condensed and recycled for reuse.

The porous media preferably may have an ultra thin coating of active chemical on the extended surfaces of porous media after evaporation of the solvent. The coating may be continuous or discontinuous. The coating may be as thin as a single molecule or have a thickness of multiple molecules. Preferably, the pore openings in the porous media are not permitted to “plug” with active chemical so that the extended internal surfaces are exposed and are coated with a very thin layer of active chemical.

Porous media, such as inorganic particles of silica gel, alumina, diatomaceous earth, zeolites, and the like, may be infused with an active chemical by deposition upon evaporation of the solvent from a solution containing active chemical. Preferably, the solvent has a low boiling point and a high dissolving capability for the active chemical. Deposition of CIPC, for example, may be advantageously performed from a CIPC-methanol solution. Methanol forms a concentrated solution of CIPC, e.g., 78% by wt. CIPC and 22% by wt. methanol. Further, methanol has a low boiling point, which permits suitable evaporation, condensation and recovery. Other useful solvents include isopropyl alcohol, ethanol, propylene glycol, and the like.

Porous media, such as, for example silica gel and alumina, have extended surfaces per unit volume and per unit weight. Solution coating of such media facilitates use of such media (coated with an active chemical, such as, for example, CIPC) as a passive system to treat stored crops, for example, by sublimation of the active chemical from the large extended surface of the porous media in the presence of a stored crop to be treated.

The porous media can also be an organic fibrous media, so long as such media is not soluble in any solvent used to deposit an active chemical. Further, such fibrous media would preferably not be adversely affected by evaporating the solvent at or near its boiling point.

Additionally, recovery of the solvent to prevent contamination of the atmosphere and to economically recover the solvent for reuse can be a significant aspect of the deposition of active chemicals from solutions.

The concentration of active chemical in a suitable solvent may vary from very dilute to very concentrated. Generally, an optimal concentration may be determined to provide an optimal coating thickness of active chemical, which does not “plug” surface pores in the porous media. Generally, concentrated solutions can be employed, which may utilize less solvent and require less energy and less condensation surface to recover evaporated solvent. However, a dilute solution may provide a thinner, more uniform coating on the extended surface of the porous media. Once the porous media is coated with an active chemical (e.g., CIPC), the porous media may be stored in closed containers for a prolonged period and then shipped to remote locations for ultimate use as a sublimation treatment of crops with the active chemical.

Some active chemicals, such as CIPC, have a very low vapor pressure at temperatures of room temperature and below. Storage in a sealed container will permit the active chemical to sublimate until the partial pressure of the active chemical in the atmosphere is in equilibrium with the vapor pressure of the active chemical at the storage temperature of the porous media. Thus, even storage at room temperature can result in very little loss of the active chemical, since the volume of atmosphere in the sealed container is sufficiently limited such that equilibrium of partial pressure and vapor pressure can be quickly reached with very minimal loss of active chemical. Storage and shipment of the treated porous media without significant loss of active chemical is significant to the ultimate utility of a passive system for introducing, via sublimation, of an active chemical to stored crops. Further, shipment of such coated porous media is generally safe.

Generally, active chemicals can be infused into/onto porous media at a central processing location, and then shipped/transported (as treated porous media) to locations of use. This may be successfully done with various active chemicals, such as CIPC, that have a very low vapor pressure at the storage and shipment temperatures generally encountered.

Alternatively, a mobile infusion treatment plant could be constructed on/in a suitable trailer, whereby the mobile unit could be transported to a general location central geographically to ultimate use of the treated porous media.

Once an active chemical, such as CIPC, is coated upon a porous media, a second coating of a different chemical may be advantageously applied. Such top coating may be a chemical that is immiscible with CIPC and evaporates or sublimates slowly to expose the CIPC coating on a time-release manner. A time-release passive treatment system is desirable in that the CIPC-coated porous media may be placed in a storage facility at the same time as the potatoes are stored, yet the CIPC is exposed after the potatoes have suberized.

CIPC sublimates at potato storage temperatures to effect a concentration of about 0.1 micrograms/liter in the headspace of the storage facility. Such a concentration is effective to maintain stored potatoes in a non-sprouting condition. Appropriate rates of sublimation to effect such a concentration are dependent upon the extensive surface area of CIPC available to sublimate.

The quantity of CIPC necessary to maintain a desired headspace atmosphere is generally in the range of about 0.5 to 2.0 ppm of the potatoes present. The CIPC surface area necessary for appropriate sublimation depends upon the quantity of stored potatoes. However, if the porous media contains a very thin coating, then CIPC present at the 0.5 to 2.0 ppm level will generally be sufficient to provide the appropriate CIPC surface area.

Given the effectiveness of combination treatments wherein an initial treatment with 1,4 DMN is followed by a CIPC treatment, porous media containing a base layer of CIPC with a top layer of 1,4 DMN may be especially efficacious. Although CIPC is soluble in 1,4 DMN, the 1,4 DMN may be applied as a vapor or liquid wherein the CIPC-coated porous media is at a cold temperature to limit any solubilizing of the CIPC layer by the 1,4 DMN coating.

An inorganic porous media with an extensive surface having a top coating of 1,4 DMN over a base layer of CIPC exposes stored potatoes to 1,4 DMN vapor first, followed by CIPC vapor later. Such a combination may delay exposure of the CIPC base layer until after the potatoes have suberized. Early treatment of stored potatoes with 1,4 DMN aerosols has generally shown an advantageous effect upon stored potatoes. (See U.S. Pat. Nos. 5,965,489; 6,310,004; and 6,375,999.)

Besides solutions of CIPC in various desirable solvents, such as methanol, isopropanol, 1,4 DMN and the like, a small amount of such solvents in molten CIPC can significantly reduce the viscosity and surface tension of the molten CIPC, enabling good infusion of the molten material into the interior skeletal surfaces of alumina, silica gel, diatomaceous earth and the like. Even as little as 2% by weight of such solvents can have a significant effect upon the liquification and infusability of molten CIPC.

Because 1,4 DMN has sprout inhibiting properties as well as a high boiling point, mixtures of small concentration of 1,4 DMN with molten CIPC can be advantageous when infusing porous inorganic media with molten CIPC. A media containing a mixture of both CIPC and 1,4 DMN may be very useful in that the 1,4 DMN, being more volatile, will tend to evaporate in large quantities at first with CIPC sublimation being minimized for a period of time, which mixtures may serve as a delayed-release system for CIPC vapors.

Carvone is a volatile terpene approved as an active chemical in the EU. CIPC may be dissolved in carvone and coated as a solution to deposit a mixture of these upon an extended surface of a porous media. Other terpenes and essential volatile oils such as clove, mint, and the like, may also be used.

What is claimed is:

1. A method of infusing a chemical agent into a porous media comprising:
forming a solution of said chemical agent in a suitable solvent;
introducing said chemical agent solution into contact with said porous media; and
evaporating said solvent to deposit said chemical agent onto/into said porous media.

2. The method of claim 1, wherein said porous media is substantially an inert inorganic material.

3. The method of claim 2, wherein said porous media is selected from a class of materials including silica gel and alumina.

4. The method of claim 2, wherein said media is a fibrous material.

5. The method of claim 1, wherein the chemical agent is chloroisopropyl carbamate (CIPC).

6. A method of placing a dual coating of active chemicals upon the extended surface of an inorganic porous media comprising:
coating said porous media with a solution of a solute in a volatile solvent;
evaporating said solvent to deposit a thin coating of said solute upon the extended surface of said porous media; and
coating said porous media with a liquid chemical to form a thin layer of said liquid chemical on top of said base solute layer.

7. The method of claim 6, wherein said solute to CIPC and said liquid chemical is 1,4 DMN.

8. The method of claim 6, wherein said solute is CIPC and said liquid chemical is carvone.

9. The method of claim 6, wherein said porous media is silica gel or alumina.

10. A method of infusing a porous media within a solution comprising a solute of a first active chemical agent and a solvent of a second active chemical agent.

11. The method of claim 10, wherein said solute is CIPC and said solvent is 1,4 DMN.
